(19) United States
(12) Patent Application Publication
(10) Pub. No.: US 2022/0324460 A1
(43) Pub. Date: Oct. 13, 2022

(54) INFORMATION OUTPUT SYSTEM, SERVER DEVICE, AND INFORMATION OUTPUT METHOD

(71) Applicant: TOYOTA JIDOSHA KABUSHIKI KAISHA, Toyota-shi (JP)

(72) Inventors: Yui TAGAMI, Fuchu-shi (JP); Toshifumi NISHIJIMA, Kasugai-shi (JP)

(73) Assignee: TOYOTA JIDOSHA KABUSHIKI KAISHA, Toyota-shi (JP)

(21) Appl. No.: 17/653,169

(22) Filed: Mar. 2, 2022

(30) Foreign Application Priority Data
Apr. 8, 2021 (JP) 2021-066091

(51) Int. Cl. B60W 40/08; G10L 15/22

(52) U.S. Cl. CPC B60W 40/08; G10L 15/22; B60W 2040/089; G10L 2015/223

(57) ABSTRACT

An information output system includes a speech acquisition unit configured to acquire the speech of a user, a holding unit configured to hold intention information associated with a question and intention information associated with a task in the hierarchical structure for each task, an identification unit configured to identify to which of the intention information, held in the holding unit, the content of the speech of the user corresponds, an output determination unit configured to determine to output a question when the intention information associated with the question is identified by the identification unit, and a task execution unit configured to execute a task when the intention information associated with the task is identified by the identification unit. A question held in the holding unit includes content for deriving intention information at a hierarchical level different from the hierarchical level of the associated intention information.

### CROSS-REFERENCE TO RELATED APPLICATION

This application claims priority to Japanese Patent Application No. 2021-066091 filed on Apr. 8, 2021, incorporated herein by reference in its entirety.

### BACKGROUND

### 1. Technical Field

The present disclosure relates to a technique that outputs information to a user.

### 2. Description of Related Art

WO2020/070878 discloses an agent device including the agent function unit that, based on the meaning of a voice collected by the microphone, generates an agent voice for speaking to a vehicle occupant and then causes the speaker to output the generated agent voice. This agent device has a plurality of sub-agent functions assigned to the command functions and, when the reception of a command is recognized from an occupant's voice, the agent device performs the sub-agent function assigned to the recognized command.

### SUMMARY

It is preferable that, even if the user does not explicitly speak a command to be entered, an appropriate command can be derived from a conversation between the user and the agent.

The present disclosure provides a technique that can appropriately narrow down a user's intention.

A first aspect of the present disclosure relates to an information output system including a speech acquisition unit, a holding unit, an identification unit, an output determination unit, and a task execution unit. The speech acquisition unit is configured to acquire the speech of a user. The holding unit is configured to hold intention information associated with a question and intention information associated with a task in the hierarchical structure for each task. The identification unit is configured to identify to which of the intention information, held in the holding unit, the content of the speech of the user corresponds. The output determination unit is configured to determine to output a question when the intention information associated with the question is identified by the identification unit. The task execution unit is configured to execute a task when the intention information associated with the task is identified by the identification unit. A question held in the holding unit includes content for deriving intention information at a hierarchical level different from the hierarchical level of the associated intention information.

A second aspect of the present disclosure relates to a server device. The server device includes a holding unit, an identification unit, an output determination unit, and a task execution unit. The holding unit is configured to hold intention information associated with a question and intention information associated with a task in the hierarchical structure for each task. The identification unit is configured to identify to which of the intention information, held in the holding unit, the content of the speech of a user corresponds. The output determination unit is configured to determine to output a question when the intention information associated with the question is identified by the identification unit. The task execution unit is configured to execute a task when the intention information associated with the task is identified by the identification unit. A question held in the holding unit includes content for deriving intention information at a hierarchical level different from the hierarchical level of the associated intention information.

A third aspect of the present disclosure relates to an information output method. The information output method includes acquiring, holding, identifying, determining, and executing. The acquiring acquires the speech of a user. The holding holds intention information associated with a question and intention information associated with a task in the hierarchical structure for each task. The identifying identifies to which of the intention information, held in the holding unit, the content of the speech of the user corresponds. The determining determines to output a question when the intention information associated with the question is identified. The executing executes a task when the intention information associated with the task is identified. A question that is held includes content for deriving intention information at a hierarchical level different from the hierarchical level of the associated intention information.

The present disclosure provides a technique that can appropriately narrow down a user's intention.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing an information output system in an embodiment and is a diagram showing an example of a conversation between a user and the agent of a terminal device;

FIG. 2 is a diagram showing a functional configuration of the information output system;

FIG. 3 is a diagram showing a functional configuration of an information processing unit;

FIG. 4 is a diagram showing a plurality of pieces of intention information held in a holding unit; and

FIG. 5 is a flowchart of processing for performing an interaction with a user.

### DETAILED DESCRIPTION OF EMBODIMENTS

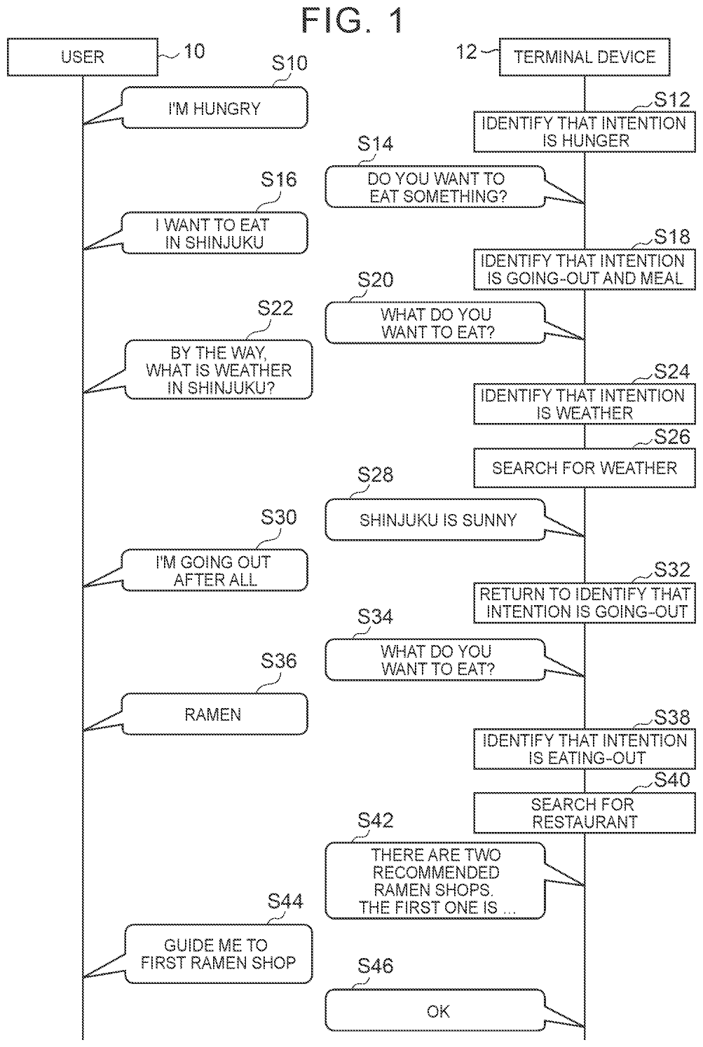

FIG. 1 is a diagram showing an information output system in an embodiment, and shows an example of a conversation between a user 10 and the agent of a terminal device 12. The information output system, which has the function to converse with the user 10, uses the agent of the terminal device 12 to output information to the user 10 in the form of an image and a voice.

The agent is displayed as the image of a character on the display of the terminal device for exchanging information with the user 10 interactively. The agent interacts with user 10 using at least one of an image and a voice. The agent recognizes the content of a speech of the user 10 and responds according to the content of the speech.

The user 10 speaks “I'm hungry” (S10). The terminal device 12 analyzes the speech of the user 10 and identifies that the intention of the user 10 is hunger (S12). That is, from the speech of the user 10, the terminal device 12 identifies the intention of the user 10. In response to the identified intention, the agent of the terminal device 12 asks “Do you want to eat something?” (S14).

The user 10 replies to the question by speaking “I want to eat in Shinjuku” (S16). The terminal device 12 analyzes the speech of the user 10 and identifies that the intention is going-out and meal (S18) and, then, the agent asks “what do you want to eat?” (S20).

The user 10 does not answer the question and asks “By the way, what is the weather in Shinjuku?” (S22). The terminal device 12 analyzes the speech of the user 10 and identifies that the intention is weather (S24) and executes the weather search task to acquire the weather information (S26). Based on the acquired weather information, the agent responds with “Shinjuku is sunny” (S28).

The user 10 speaks “I'm going out after all” in response to the output of the agent (S30). The terminal device 12 analyzes the speech of the user 10 and determines to return to identify that the intention is going-out (S32). The agent asks again “What do you want to eat?” as in S20 (S34).

The user 10 replies to the question by speaking “Ramen” (S36). The terminal device 12 analyzes the speech of the user 10 and identifies that the intention is eating-out (S38) and then executes the restaurant search task to acquire the restaurant information (S40). Based on the acquired restaurant information, the agent makes a proposal that “There are two recommended ramen shops. The first one is shop A and the second one is shop B.”

The user 10 responds to the proposal by speaking “Guide me to the first ramen shop” (S44). The agent of the terminal device 12 outputs “OK” and starts guidance (S46).

In this way, the terminal device 12 can interact with the user 10 via the agent and, from the speech of the user, derive an intention to go out for a meal. As shown in S22, the user 10 sometimes speaks without replying to the received question. In this case, as shown in S24, it is natural to respond according to the speech of the user 10. On the other hand, it is unnatural to ignore the flow of the previous interaction and therefore, in S34, the terminal device 12 returns to the flow of the previous interaction, which has been interrupted, and speaks to resume the previous interaction. In this way, while responding to a user's task request that suddenly occurs during an interaction, the information output system allows the interaction to be naturally continued by appropriately returning to the topic.

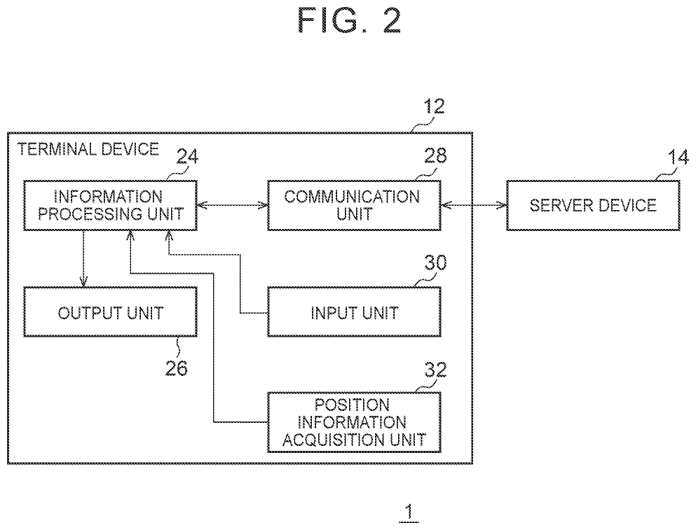

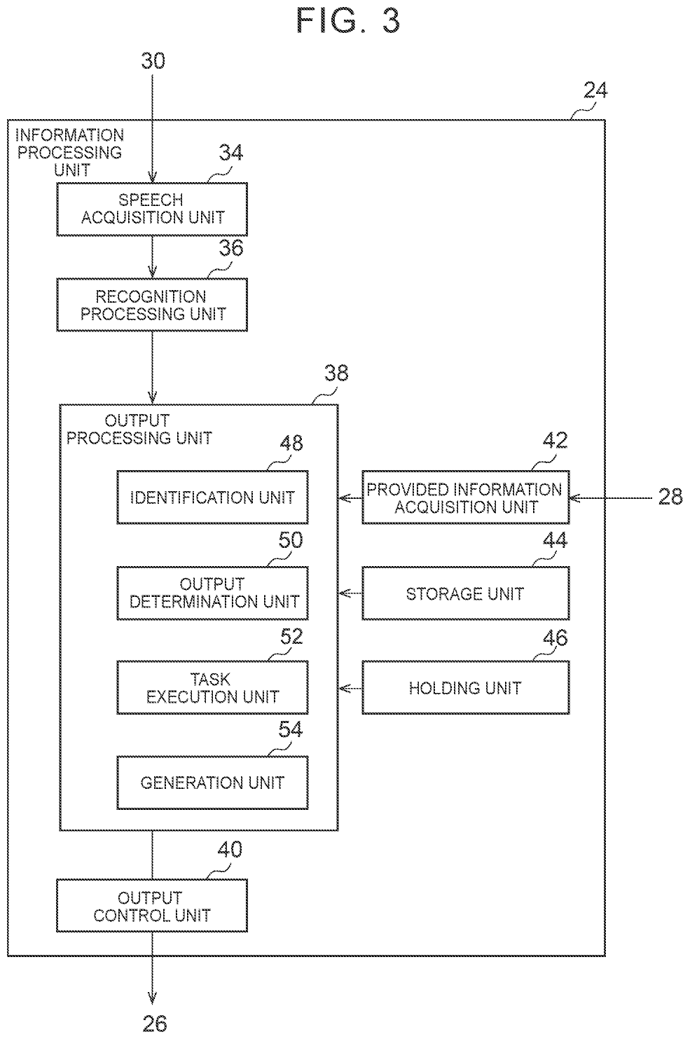

FIG. 2 is a diagram showing a functional configuration of an information output system 1. In FIG. 2 and FIG. 3 that will be described later, each of the components described as functional blocks, which perform various types of processing, can be configured by hardware such as a circuit block, a memory, and any other LSI or implemented by software by executing a program loaded in the memory. Therefore, it is to be understood by those skilled in the art that these functional blocks can be implemented in various forms by hardware only, by software only, or by a combination of hardware and software and, therefore, the implementation of these functional blocks is not limited to any one of the forms.

The information output system 1 includes the terminal device 12 and a server device 14. The server device 14, provided in a data center, can communicate with the terminal device 12. The server device 14 holds provided information and sends the provided information to the terminal device 12. The provided information, such as shop information, includes the name and address of a shop and the goods or services provided by the shop. The provided information may be advertising information on goods or services, weather information, news information, and the like. The provided information is categorized by genre; for example, restaurants are categorized by genre such as ramen, Chinese food, Japanese food, curry, Italian food, and so on.

The terminal device 12 includes an information processing unit 24, an output unit 26, a communication unit 28, an input unit 30, and a position information acquisition unit 32. The terminal device 12 may be a terminal device mounted on the vehicle on which the user rides or may be a mobile terminal device carried by the user. The communication unit 28 communicates with the server device 14. A terminal ID is attached to the information sent from the communication unit 28 to the server device 14.

The input unit 30 accepts an input from the user 10. The input unit 30, such as a microphone, a touch panel, and a camera, accepts voices, operations, and actions from the user 10. The position information acquisition unit 32 acquires the position information on the terminal device 12 using the satellite positioning system. The position information on the terminal device 12 is time stamped.

The output unit 26, at least one of a speaker and a display, outputs information to the user. The speaker of the output unit 26 outputs the voice of the agent, and the display of the output unit 26 displays the agent and guidance information.

The information processing unit 24 analyzes a speech of the user entered from the input unit 30, causes the output unit 26 to output a response to the content of the speech of the user, and performs conversation processing between the agent and the user.

FIG. 3 shows a functional configuration of the information processing unit 24. The information processing unit 24 includes a speech acquisition unit 34, a recognition processing unit 36, an output processing unit 38, an output control unit 40, a provided information acquisition unit 42, a storage unit 44, and a holding unit 46. In addition, the output processing unit 38 includes an identification unit 48, an output determination unit 50, a task execution unit 52, and a generation unit 54.

The speech acquisition unit 34 acquires a speech of the user entered from the input unit 30. The speech of the user is acquired as acoustic signals. In addition, the speech acquisition unit 34 may acquire user's input information entered by the user from the input unit 30 in characters. The speech acquisition unit 34 may use a voice extraction filter to extract the speech.

The recognition processing unit 36 recognizes the content of the speech of the user acquired by the speech acquisition unit 34. The recognition processing unit 36 performs the voice recognition processing for converting the speech of the user into text and, then, performs the language recognition processing for understanding the content of the text.

The provided information acquisition unit 42 acquires guidance information from the server device 14 according to the content of the speech of the user recognized by the recognition processing unit 36. For example, when the user speaks “I want to eat ramen”, the provided information acquisition unit 42 acquires the provided information including the tag information “restaurant” or “ramen” and the provided information including the word “ramen”. In addition, based on the position information on the terminal device 12, the provided information acquisition unit 42 may acquire the information on the shops located around the terminal device 12. That is, the provided information acquisition unit 42 may acquire the search result obtained by performing a search through the provided information or may collectively acquire the information on the shops located around the vehicle instead of performing a search.

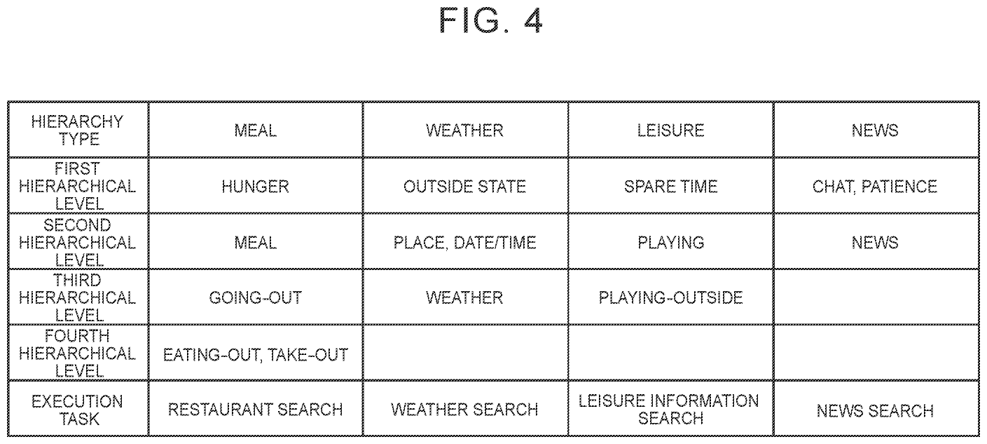

The holding unit 46 holds a plurality of pieces of intention information classified in a hierarchy structure for each task. The user's intention information, obtained by analyzing the speech of the user, indicates the content that the user is trying to convey in the speech. The intention information held in the holding unit 46 will be described below with reference to FIG. 4.

FIG. 4 is a diagram showing a plurality of pieces of intention information held in the holding unit 46. In the example shown in FIG. 4, the first hierarchical level is the top hierarchical level, with the second hierarchical level subordinate to it. The number of hierarchy levels varies depending on the type of a task. For the same task type, the same hierarchy level may include two or more pieces of intention information.

For example, in the eating and drinking task, the first hierarchical level is associated with the intention information “hunger”, the second hierarchical level is associated with the intention information “meal”, the third hierarchical level is associated with the intention information “going-out”, and the fourth hierarchical level is associated with the intention information “eating-out” and “take-out.” In the eating and drinking task, when the intention information associated the fourth hierarchical level, that is, the intention information “eating-out” and “take-out” is identified, the restaurant search task is executed. In this way, each piece of intention information is held in the holding unit 46 with a hierarchy type and a hierarchy level associated with the intention information.

When the intention information at the lowest hierarchical level is identified, the task corresponding to the intention information is executed. For example, in the weather task, when the intention information “weather” is identified, the weather search is performed; similarly, in the leisure task, when the intention information “playing outside” is identified, the leisure information search is performed.

The holding unit 46 holds a question in association with each piece of intention information. This question is used for deriving another piece of intention information different from the associated intention information. The question is held in text. By outputting the question associated with the identified intention information, another piece of intention information can be derived from the user.

The holding unit 46 holds a question that defines the content for deriving the intention information at the next lower hierarchical level of the intention information associated with the question. That is, the question associated with the intention information at the first hierarchical level defines the content for deriving the intention information at the second hierarchical level that is subordinate to the intention information at the first hierarchical level. For example, when the intention information “hungry” shown in FIG. 4 is identified, a question for deriving the intention information “meal”, which is subordinate to the identified intention information, is output. Defining in advance a question that derives the intention information at the next lower hierarchical level in this way finally makes it possible to identify the intention information at the lowest hierarchical level and to execute the associated task. In other words, no task is executed until the intention information at the lowest hierarchical level is identified.

A plurality of questions may be associated with one piece of intention information. In this case, one of the associated questions may be output or one of the questions is selected for output with a predetermined probability.

The holding unit 46 holds dictionary data in which intention information is associated with a specific word. This allows user's intention information to be identified when the user speaks a specific word. For example, in the dictionary data, specific words such as “hungry” and “starving” are associated with the intention information “hungry”, and specific words such as “sunny” and “rainy” are associated with the intention information “outside state.”

The intention information held in the holding unit 46 in the hierarchical structure includes two types of intention information: one is intention information associated with a question and the other is intention information associated with a task. For example, in the hierarchical structure of eating and drinking, the intention information at the first hierarchical level to the third hierarchical level is associated with questions, and the intention information at the fourth hierarchical level, which is the lowest hierarchical level, is associated with a task. This makes it possible to output a question for deriving the intention information at the next lower-level when the intention information at a high hierarchical level is identified and, finally, to derive the intention information corresponding to a task.

The description returns to FIG. 3. The output processing unit 38 generates a response to the content of the speech of the user, recognized by the recognition processing unit 36, in the text form. The output control unit 40 controls the output of a response, generated by the output processing unit 38, so that the response is output from the output unit 26.

The output processing unit 38 can execute a task according to the content of the speech of the user for providing services. For example, the output processing unit 38 has the guidance function for providing provided information to the user. The service function provided by the output processing unit 38 includes not only the guidance function but also the music playback function, the route guidance function, the call connection function, and the terminal setting change function.

The identification unit 48 of the output processing unit 38 identifies to which of the plurality of pieces of intention information, held in the holding unit 46, the content of each speech of the user corresponds. To do so, the identification unit 48 checks whether a specific word is included in the speech of the user, extracts the specific word when it is included and, based on the extracted specific word, identifies the user's intention information. That is, the identification unit 48 refers to the dictionary data, which indicates the association between intention information and preset specific words, to identify the user's intention information. The identification unit 48 may use the neural network method to identify the user's intention information from the content of the speech of the user. In addition, when extracting a specific word, the identification unit 48 may allow notational fluctuations and small differences. Furthermore, the identification unit 48 may identify a plurality of pieces of intention information from the contents of the speech of the user.

The storage unit 44 stores the user's intention information, identified by the identification unit 48, and the interaction history such as the speeches of the user. The storage unit 44 stores the task type to which the identified intention information belongs and the time of identification. The storage unit 44 may store a predetermined number of pieces of intention information of the user identified by the identification unit 48 or may store the interaction history within a predetermined period of time from the current time. That is, the storage unit 44 discards old intention information when the predetermined number of pieces of intention information is accumulated or discards the interaction history when the predetermined period of time has elapsed from the identified time. This makes it possible to discard the old intention information while storing a certain amount of interaction history.

When the speech of the user does not include a specific word, the identification unit 48 determines whether the user has answered positively or negatively. When a specific word is not included and the user has answered positively or negatively, the identification unit 48 may identify the user's intention information based on the previous intention information, the speech of the user, and the question content. This makes it possible to identify the user's intention information when the user answers “yes” or “no” even if a specific word is not included in the speech.

The output determination unit 50 obtains a question, associated with the identified intention information, from the holding unit 46 and determines to output the obtained question. The question associated with the intention information, provided for deriving the next lower-level intention information subordinate to that intention information, can be used to narrow down the user's intention. This allows the user's intention to be narrowed down, making it possible to carry out an interaction smoothly in accordance with the user's intention. The output determination unit 50 may select one of the questions, associated with the identified intention information, and determine to output the selected question. When selecting one of the questions from the questions, the output determination unit 50 may select a question randomly or may select the best question based on the previous intention information.

A response is output based on the user's intention information identified by the identification unit 48. Therefore, even when the user suddenly changes the topic and requests another type of task, the output processing unit 38 can derive an appropriate task for responding to a change in the topic, as in S20 to S28 in the interaction example shown in FIG. 1.

The storage unit 44 stores the interaction history. This interaction history also includes a case in which no answer has been given to a question such as the question shown in S20 in FIG. 1. In S18 in FIG. 1, since the speech of the user has changed to a piece of intention information included in another hierarchy, the descent in the hierarchy remains suspended. To resume the processing that has been suspended, the output determination unit 50 detects an unanswered question from among the questions in the interaction history stored in the storage unit 44 and then determines to output the detected question again. When to output the question again may be the time immediately after the execution of another type of task as shown in S34 in FIG. 1. As a result, after the completion of another type of task, the interaction for deriving a task that is not yet completed can be resumed as shown in S32 and S34 in FIG. 1. In this case, instead of performing the interaction sequentially, one hierarchical level at a time, from a high hierarchical level in the hierarchy, the processing may proceed easily to the position of the identified intention information.

The output determination unit 50 may determine not to output a question associated with intention information. In this case, not a question but a mere interjection is output. For example, the probability at which a question associated with intention information is to be output may be set in advance for each piece of intention information. For example, when the intention information “chat” is identified, the probability at which a question is to be output may be relatively low (about 10 percent); conversely, when the intention information “hungry” is identified, the probability at which a question is to be output may be relatively high (about 90 percent). When a plurality of pieces of intention information is identified by the identification unit 48, the output determination unit 50 may determine to output the question associated with the intention information at the lowest hierarchical level.

The content of a question associated with intention information is defined not only to narrow down to the intention information at the next lower hierarchical level but also, depending upon the answer, to derive a piece of intention information belonging to another hierarchy type. For example, when the user speaks negatively to the question “Do you want to eat something?” in S14 shown in FIG. 1, the intention information “patience” is identified. This “patience” intention information is included in the news hierarchy, not in the meal hierarchy, as shown in FIG. 4. In this way, depending on the answer to a question, it is possible to jump to another type of hierarchy for continuing the conversation.

The task execution unit 52 executes the corresponding task when the intention information at the lowest hierarchical level is identified. For example, the task execution unit 52 performs the restaurant search when the intention information “eating-out” shown in FIG. 4 is identified and, via the provided information acquisition unit 42, acquires the restaurant information from the server device 14. In addition, the task execution unit 52 may issue an instruction to put the music playback device or the navigation device in operation.

The generation unit 54 generates text to be spoken by the agent. The generation unit 54 generates a textual question determined by the output determination unit 50. The generation unit 54 may set the expression of a question, held in the holding unit 46, according to the type of the agent. For example, the generation unit 54 may generate a question in a dialect. The generation unit 54 may generate text other than a question determined by the output determination unit 50 and may generate text according to the user's intention information. In addition, when the user's intention information is not identified, the generation unit 54 may generate daily conversations such as simple interjections and greetings. The output control unit 40 causes the output unit 26 to output text, generated by the generation unit 54, as a voice or an image.

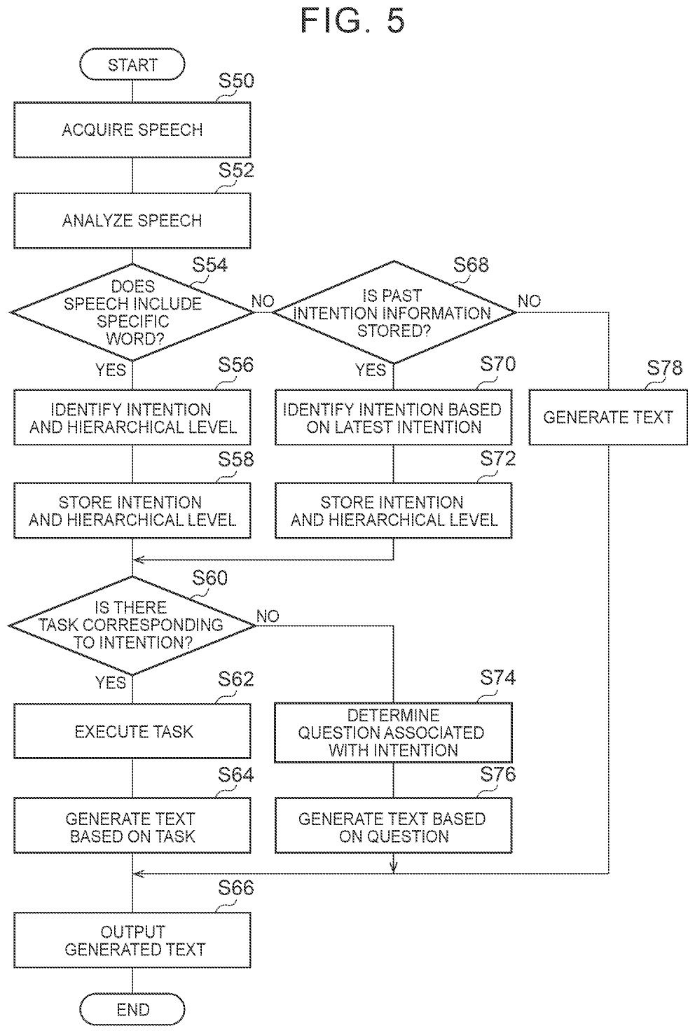

FIG. 5 is a flowchart of processing for performing an interaction with the user. The speech acquisition unit 34 acquires a speech of the user 10 from the input unit 30 (S50). The recognition processing unit 36 analyzes the speech of the user 10 and recognizes the content of the speech (S52).

The identification unit 48 determines whether the speech of the user 10 includes a specific word (S54). When the speech of the user 10 includes a specific word (Y in S54), the identification unit 48 refers to the dictionary data, held in the holding unit 46, to identify the intention information associated with the specific word and the hierarchical level of the intention information (S56). The storage unit 44 stores the intention information identified by the identification unit 48 (S58).

The task execution unit 52 determines whether there is a task corresponding to the identified intention information (S60). That is, the task execution unit 52 determines whether the identified intention information is positioned at the lowest hierarchical level. When there is a task corresponding to the identified intention information (Y in S60), the task execution unit 52 executes the task (S62). Based on the execution result of the task execution unit 52, the generation unit 54 generates a text to be used as a response to the user 10 (S64). The output control unit 40 causes the output unit 26 to output the generated text (S66) and finishes this processing.

When there is no task corresponding to the identified intention information (N in S60), the output determination unit 50 determines to output a question associated with the identified intention information (S74). This question is used to derive the intention information at the next lower hierarchical level subordinate to the current hierarchical level so that a task can finally be derived. The generation unit 54 generate a text based on the question determined by the output determination unit 50 (S76). For example, since questions are held in the holding unit 46 in the text form, the generation unit 54 may only take out the question, determined by the output determination unit 50, from the holding unit 46. The output control unit 40 causes the output unit 26 to output the generated text (S66) and ends this processing.

When the speech of the user 10 does not include a specific word (N in S54), the identification unit 48 determines whether the past intention information is stored in the storage unit 44 (S68). When the past intention information is not stored (N in S68), the generation unit 54 generates a response sentence according to the speech of the user 10 (S78). The output control unit 40 causes the output unit 26 to output the generated text (S66) and ends this processing.

When the past intention information is stored (Y in S68), the identification unit 48 identifies the intention information of the user 10 based on the latest intention information, the output of the agent, and the speech of the user 10 (S70). For example, when the agent outputs “Do you want to eat something?” and the user 10 replies “Yes”, the identification unit 48 identifies the intention information of the user 10 as “meal.” When the user 10 replies “No,” the identification unit 48 identifies the intention information of the user as “patience.” The storage unit 44 stores the identified intention information (S72). After that, the processing proceeds to S60 described above to perform the processing in the subsequent steps.

It should be noted that the embodiment is merely an example, and it is to be understood by those skilled in the art that various modifications are possible for a combination of the components and that such modifications are also within the scope of the present disclosure.

Although the mode in which the terminal device 12 acquires the provided information from the server device 14 is shown in the embodiment, the present disclosure is not limited to this mode. For example, the terminal device 12 may hold the provided information in advance.

In addition, the present disclosure is not limited to the mode in which the terminal device 12 performs the speech recognition processing and the response text generation processing. Instead, the server device 14 may perform at least one of the speech recognition processing and the response text generation processing. For example, all of the configuration of the information processing unit 24 of the terminal device 12 may be provided in the server device 14. When the information processing unit 24 is provided in the server device 14, the sound signal received by the input unit 30 of the terminal device 12 and the position information acquired by the position information acquisition unit 32 of the terminal device 12 are sent from the communication unit 28 to the server device 14. Then, the information processing unit 24 of the server device 14 generates speech text and causes the output unit 26 of the terminal device 12 to output the generated speech text.

Although the identification unit 48 identifies the intention information corresponding to a task based on the content of the speech of the user in the embodiment, the present disclosure is not limited to this mode. For example, the identification unit 48 may identify the intention information corresponding to a task based on the content of the previous speech and the content of the current speech of the user or may identify the intention information corresponding to a task by identifying a plurality of pieces of intention information.

What is clamed is:

1. An information output system comprising:
a speech acquisition unit configured to acquire a speech of a user;
a holding unit configured to hold intention information associated with a question and intention information associated with a task in a hierarchical structure for each task;
an identification unit configured to identify to which of the intention information, held in the holding unit, content of the speech of the user corresponds;
an output determination unit configured to determine to output a question when the intention information associated with the question is identified by the identification unit; and
a task execution unit configured to execute a task when the intention information associated with the task is identified by the identification unit, wherein a question held in the holding unit includes content for deriving intention information at a hierarchical level different from a hierarchical level of the associated intention information.

2. The information output system according to claim 1, wherein:
the question held in the holding unit includes content for deriving intention information at a hierarchical level lower than the hierarchical level of the associated intention information; and
in the hierarchical structure, the intention information associated with the task is at a hierarchical level lower than a hierarchical level of the intention information associated with the question.

3. The information output system according to claim 1, further comprising a storage unit configured to store a history of past interactions, wherein the output determination unit is configured to determine to output a question again, the question being a question that was output in the past and for which no answer has been obtained from the user.

4. The information output system according to claim 1, wherein the identification unit is configured to identify to which of the intention information, held in the holding unit, the content of the speech of the user corresponds based on the speech of the user and previously identified intention information.

5. A server device comprising:
a holding unit configured to hold intention information associated with a question and intention information associated with a task in a hierarchical structure for each task;
an identification unit configured to identify to which of the intention information, held in the holding unit, content of a speech of a user corresponds;
an output determination unit configured to determine to output a question when the intention information associated with the question is identified by the identification unit; and
a task execution unit configured to execute a task when the intention information associated with the task is identified by the identification unit, wherein a question held in the holding unit includes content for deriving intention information at a hierarchical level different from a hierarchical level of the associated intention information.

6. An information output method comprising:
acquiring a speech of a user;
holding intention information associated with a question and intention information associated with a task in a hierarchical structure for each task;
identifying to which of the intention information, held in the holding unit, content of the speech of the user corresponds;
determining to output a question when the intention information associated with the question is identified; and
executing a task when the intention information associated with the task is identified, wherein a question that is held includes content for deriving intention information at a hierarchical level different from a hierarchical level of the associated intention information.
